(19) United States
(12) Patent Application Publication
(10) Pub. No.: US 2025/0215949 A1
(43) Pub. Date: Jul. 3, 2025

(54) DAMPING ELEMENT AND RETAINING SYSTEM FOR A VEHICLE

(71) Applicant: HELLA GmbH & Co. KGaA, Lippstadt (DE)

(72) Inventors: Theodor HUESER, Geseke (DE); Benjamin GROTHE, Wickede (DE); Jianqiu ZHANG, Datteln (DE); Alexander FOOT, Bueren (DE)

(73) Assignee: HELLA GmbH & Co. KGaA, Lippstadt (DE)

(21) Appl. No.: 19/080,718

(22) Filed: Mar. 14, 2025

Related U.S. Application Data
(63) Continuation of application No. PCT/EP2023/072571, filed on Aug. 16, 2023.

(30) Foreign Application Priority Data
Sep. 14, 2022 (DE) 10 2022 123 432.0

(51) Int. Cl. F16F 1/373; F16F 1/377; F16F 15/08; F16M 13/02

(52) U.S. Cl. CPC F16F 1/3732; F16F 1/377; F16F 15/08; F16M 13/022; F16F 2224/025; F16F 2230/36; F16F 2234/02

(57) ABSTRACT

A damping element for the attachment of a vehicle component to the remainder of a vehicle. The damping element can be in the form of a one-piece damping element. The damping element has a first damping cylinder and a second damping cylinder, wherein the two damping cylinders are connected to each other via a connecting cylinder and the damping element is designed such that, when the damping element is in a position of use, only the first and second damping cylinders bear in a force-transmitting manner against the vehicle component and against the remainder of the vehicle in the radial and axial direction. A retaining system is also provided.

This nonprovisional application is a continuation of International Application No. PCT/EP2023/072571, which was filed on Aug. 16, 2023, and which claims priority to German Patent Application No. 10 2022 123 432.0, which was filed in Germany on Sep. 14, 2022, and which are both herein incorporated by reference.

### BACKGROUND OF THE INVENTION

### Field of the Invention

The present invention relates to a damping element for the attachment of a vehicle component to a remainder of a vehicle and to a retaining system for a vehicle for attachment of a vehicle component to a remainder of the vehicle.

### Description of the Background Art

Damping elements and retaining systems for vehicles are already known from the prior art. The known retaining systems have at least one retaining device group with, in each case, a first retaining device arranged in a force-transmitting manner on the remainder of the vehicle, a second retaining device corresponding to the first retaining device and arranged in a force-transmitting manner on the vehicle component, and a damping element arranged between the first and second retaining devices. The known damping elements are designed as one-piece damping elements, for example.

### SUMMARY OF THE INVENTION

It is therefore an object of the present invention to improve a damping element and a retaining system for a vehicle.

This object is attained in an example by a damping element, which is characterized in that the damping element has a first damping cylinder and a second damping cylinder, wherein the two damping cylinders are connected to one another by means of a connecting cylinder, and the damping element is designed such that, when the damping element is in a position of use, only the first and second damping cylinders bear against the vehicle component on the one hand and against the remainder of the vehicle on the other hand in a manner that transmits force in the radial and axial directions. In addition, this object is attained by a retaining system with the features of claim 8. The attachment of the vehicle component of the vehicle to the remainder of the vehicle by means of the damping element according to the invention and/or by means of the retaining system according to the invention can be implemented in a variety of ways here. For example, it is possible that the first damping cylinder and the second damping cylinder bear in a force-transmitting manner against sections of the vehicle component and/or of the remainder of the vehicle that are different from one another, for example by means of the retaining system according to the invention, namely by means of the first and second retaining devices of the at least one retaining device group.

An important advantage of the invention is, in particular, that a damping element and a retaining system for a vehicle are improved. On account of the design according to the invention of the damping element and the retaining system, firstly a damping element is specified that is very flexible and thus can be used advantageously for a multitude of applications. For example, a multiplicity of damping elements according to the invention of the same design can be used simultaneously for different retaining device groups of the retaining system, regardless of whether the individual retaining device group holds the vehicle component on the remainder of the vehicle along a first retaining axis or in a second retaining axis oriented perpendicular to this first retaining axis, for example with the same spatial orientation of the individual retaining device groups. The damping element according to the invention is thus universally usable, so the damping element according to the invention can also be referred to as a standardized damping element. Secondly, a retaining system is specified that has a simpler construction in terms of design and manufacturing as compared with the prior art. This is because the damping element according to the invention has the advantages explained above.

The damping element according to the invention can be freely chosen within broad suitable limits in terms of type, mode of operation, material, and dimensioning. For example, it is practical for manufacturing reasons for the first and second damping cylinders as well as the connecting cylinder to each have rounded edges.

The first and second damping cylinders can be designed to be identical to one another in their basic structure. In this way, design and manufacture are further simplified, on the one hand. On the other hand, moreover, similar or even identical deformation behavior of the two damping cylinders is also achieved.

The first damping cylinder, the second damping cylinder, and the connecting cylinder can each be designed to be rotationally symmetric about a common rotational axis, preferably that the damping element has a central retaining opening extending along the common rotational axis, especially preferably that the retaining opening is designed as a through hole. By this means, design and manufacture of the damping element according to the invention are additionally simplified. Furthermore, a radial deformation behavior of the damping element according to the invention with the two damping cylinders and the connecting cylinder is essentially identical over the entire circumference as a result. Moreover, a further advantage that the inventive damping element as a whole can be retained in a manner that is robust on the one hand and on the other hand is advantageous with respect to force transmission between the damping element according to the invention and, for example, the remainder of the vehicle. In addition, through holes are easy to manufacture and can be combined with a multiplicity of suitable retaining or attachment means that are already available on the market for a force-transmitting connection of the damping element according to the invention to, for example, the remainder of the vehicle.

The first retaining device of at least one retaining device group can have a retaining bolt corresponding to a central retaining opening of the damping element, preferably that the retaining bolt is designed as an attachment bolt, especially preferably that the attachment bolt has, at its free front end, a screw thread. For example, it is possible that a sleeve with an essentially smooth surface on the side facing the damping element according to the invention is arranged between the attachment bolt with the screw thread and the damping element according to the invention.

Further, the first retaining device of at least one retaining device group can have an attachment section, preferably that the attachment section has a screw thread corresponding to a separate threaded bolt of the retaining system, especially preferably that the attachment section is designed as a raised attachment projection. Analogous to the aforementioned improvement of the retaining system according to the invention, it is also possible here that a sleeve with an essentially smooth surface on the side facing the damping element according to the invention can be arranged between the threaded bolt with the screw thread and the damping element according to the invention.

The first and second damping cylinders can each have circumferentially uniformly distributed compression openings for elastic compression of the two damping cylinders when the damping element is conveyed into its position of use, preferably that the compression openings of the first and second damping cylinders are designed and arranged on the respective damping cylinder in an identical manner, especially preferably that the compression openings are each arranged radially with respect to a central retaining opening of the damping element. In this way an installation of the damping element, for example, which is to say a conveying of the damping element into its position of use, is substantially simplified. Furthermore, it is possible by this means to design a retaining device for receiving the damping element according to the invention, for example of the vehicle component, that is simpler in terms of design and manufacturing. A further advantage is that design and manufacture of the inventive damping element itself are additionally simplified. Also, material for the damping element according to the invention can be saved in this way. An essentially circumferentially uniform radial deformation behavior of the first and second damping cylinders of the damping element according to the invention is thereby fostered when the damping element according to the invention is conveyed into its position of use as well as when it is in this position of use.

The first and second damping cylinders can each have, on their free front end, a raised mounting surface for attachment to the remainder of the vehicle, preferably that the mounting surface is designed as a mounting surface arranged circumferentially around a central retaining opening of the damping element, especially preferably that the mounting surface is designed as a mounting surface arranged essentially between the central retaining opening and the compression openings of the damping element. As a result, there is no need for, e.g., a raised shoulder on a retaining device associated with the remainder of the vehicle to retain the damping element according to the invention. Accordingly, it is therefore possible to advantageously employ the damping element according to the invention even with already-existing designs. An essentially central force transmission between the damping element on the one side and the aforementioned retaining device on the other side is made possible despite the presence of the central retaining opening. A further advantage is that, when compression openings are present, a clear functional separation is provided between the retaining of the inventive damping element on the one hand and the elasticity of the inventive damping element necessary for, e.g., conveying the inventive damping element into its position of use on the other hand. Accordingly, a design layout of the damping element according to the invention is significantly simplified.

The damping element can be designed such that it has essentially identical deformation characteristics in the axial and radial directions. In this way the design layout, for example, of a retaining system for a vehicle for attachment of a vehicle component to a remainder of the vehicle by means of a multiplicity of retaining device groups with structurally identical damping elements according to the invention is significantly simplified, since these structurally identical damping elements each have essentially the same deformation behavior in both the radial and axial directions, regardless of whether the individual retaining device group holds the vehicle component on the remainder of the vehicle along a first retaining axis or in a second retaining axis oriented perpendicular to this first retaining axis, for example with the same spatial orientation of the individual retaining device groups.

The retaining system can have a multiplicity of retaining device groups, preferably three retaining device groups, and the retaining device groups are designed and arranged such that the vehicle component has, by means of the damping elements, essentially the same damping in the axial and radial directions relative to each of the damping elements.

The damping element can be designed as a silicone or an elastomer, preferably that the damping element is designed as a rubber elastomer, especially preferably that the damping element is made from EPDM or NBR. In this way, the one-piece, which is to say single-piece, damping element according to the invention is produced from a very suitable material for the task, wherein the abbreviation EPDM stands for ethylene propylene diene monomer rubber and the abbreviation NBR stands for nitrile butadiene rubber. However, other elastomers, for example including thermoelastomers, are fundamentally also possible, depending on the application.

The second retaining device of at least one retaining device group can be designed as a clamp that only partially encompasses the damping element when it is in its position of use and that has a clamp opening on its circumference, preferably that the clamp and the damping element are matched to one another in design such that the damping element can be conveyed into its position of use through the clamp opening, especially preferably that the clamp has a retaining projection that corresponds to the connecting cylinder and bears axially against only the first and second damping cylinders when the damping element according to the invention is in the position of use. In this way, the second retaining device is implemented in an especially simple manner in terms of design and manufacturing. This example has the further advantage that the damping element according to the invention can, on the one hand, be positioned in the second retaining device designed as a clamp by means of the retaining projection, and on the other hand the first damping cylinder and the second damping cylinder each can be individually deformed, namely as a function of the direction of load, in the case of axial loading of the damping element according to the invention. In this example of the improvement, the clamp thus ensures that both damping cylinders are deformed in the case of radial loading of the damping element according to the invention, and only one of the two damping cylinders is deformed in the case of axial loading of the damping element according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF DRAWINGS

The present invention will become more fully understood from the detailed description given hereinbelow and the accompanying drawings which are given by way of illustration only, and thus, are not limitive of the present invention, and wherein:

FIG. 1 shows an example of the retaining system according to the invention with the damping element according to the invention in a partial, perspective exploded view,

FIG. 2 shows the damping element from FIG. 1 with the second retaining device in a sectional side view, with the damping element in its position of use,

FIG. 3 shows a first variant of an example of the retaining system according to the invention with the damping element according to the invention in a partial, perspective exploded view,

FIG. 4 shows the damping element from FIG. 3 with the second retaining device in a perspective view, with the damping element in its position of use, and

FIG. 5 shows a second variant of the example in the assembled state in a partial, sectional side view.

### DETAILED DESCRIPTION

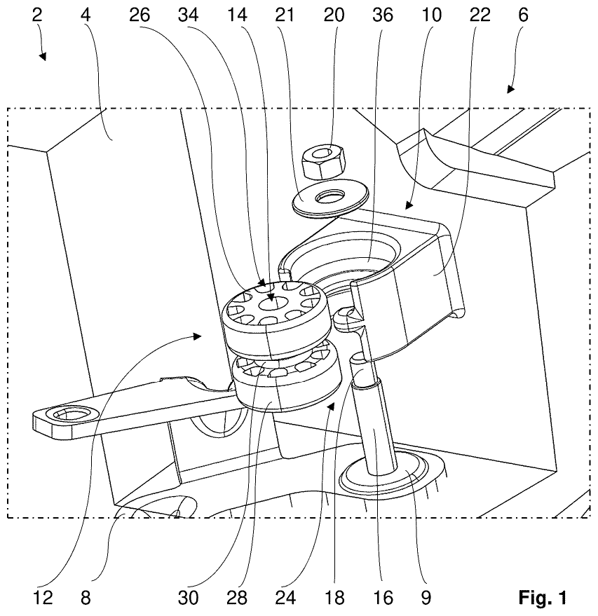

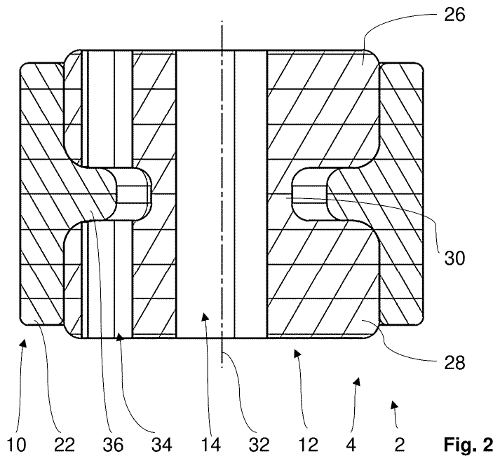

Shown strictly by way of example in FIGS. 1 and 2 is a first example of the retaining system according to the invention with the damping element according to the invention.

The retaining system 2 for a vehicle (not shown in detail) for attachment of a vehicle component 4—implemented as a vacuum pump—of the vehicle to a remainder of the vehicle comprises at least one retaining device group 6 with, in each case, a first retaining device 8 arranged in a force-transmitting manner on the remainder of the vehicle, a second retaining device 10 corresponding to the first retaining device 8 and arranged in a force-transmitting manner on the vehicle component 4, and a damping element 12 arranged between the first and second retaining devices 8, 10. The vehicle component can be a vacuum pump for the vehicle, for example. However, vehicle components of other types are also possible.

The retaining system 2 of the present first example has three retaining device groups 6 in all, wherein the three retaining device groups 6 here are designed identically to one another in the relevant parts. Only one of the three retaining device groups 6 is shown in FIG. 1. For this reason, only the depicted retaining device group 6 is explained below, wherein the explanations also apply to the other retaining device groups. Even though the other retaining device groups here are indeed designed identically to the retaining device group 6 that is shown, this is not necessarily the case. For example, it can be the case in other examples of the invention that the multiplicity of the retaining device groups is arranged such that these device groups act in retaining axes that differ from one another, wherein two of these retaining axes, for example, can be arranged perpendicular to one another. Accordingly, the individual damping elements could be loaded in the axial direction on the one hand and in the radial direction on the other hand with the same spatial orientation of the individual retaining device groups.

The retaining device groups 6 here are each designed and arranged such that the vehicle component 4 has, by means of the damping elements 12, essentially the same damping in the axial and radial directions relative to each of the damping elements 12.

In all retaining device groups 6, the first retaining device 8 has a retaining bolt 16 corresponding to a central retaining opening 14 of the damping element 12, wherein the retaining bolt 16 is designed as an attachment bolt, namely in such a manner that the attachment bolt 16 has, at its free front end, a screw thread 18. The screw thread 18 corresponds to a separate attachment nut 20 of the retaining system 2.

The second retaining device 10 is designed here as a clamp 22 that only partially encompasses the damping element 12 when it is in its position of use shown in FIG. 2 and that has a clamp opening 24 on its circumference, wherein the clamp 22 and the damping element 12 are matched to one another in design such that the damping element 12 can be conveyed into its position of use through the clamp opening 24.

The damping element 12 for the attachment of the vehicle component 4 to the remainder of the vehicle is designed as a one-piece damping element and has, according to the invention, a first damping cylinder 26 and a second damping cylinder 28, wherein the two damping cylinders 26, 28 are connected to one another by means of a connecting cylinder 30, and the damping element 12 is designed such that, when the damping element 12 is in a position of use, only the first and second damping cylinders 26, 28 bear against the vehicle component 4 on the one hand and against the remainder of the vehicle on the other hand in a manner that transmits force in the radial and axial directions. An axial as well as a radial force transmission relative to the damping element 12 is therefore possible by means of the damping element 12. The damping element 12 in this case is matched in design to the first and second retaining devices 8, 10, namely in particular dimensioned, such that, when the damping element 12 is in the position of use, only the first and second damping cylinders 26, 28 bear against the vehicle component 4 on the one hand and against the remainder of the vehicle on the other hand in a manner that transmits force in the radial and axial directions by means of the first and second retaining devices 8, 10, whereas the connecting cylinder 30 does indeed bear against the first retaining device 8, namely against the attachment bolt 16, but does not bear against the second retaining device 10 when the damping element 12 is in the position of use. See FIG. 2 in this regard. When the damping element 12 is in the position of use of, the attachment bolt 16 bears in a force-transmitting manner against an inner wall of the damping element 12 bordering the retaining opening 14.

As is apparent from FIGS. 1 and 2, the first and second damping cylinders 26, 28 are not only designed to be identical to one another in their basic structure. The first damping cylinder 26, the second damping cylinder 28, and the connecting cylinder 30 are also each designed to be rotationally symmetric about a common rotational axis 32, wherein the central retaining opening 14 of the damping element 12 extends along the common rotational axis 32 and the retaining opening 14 here is designed as a through hole.

The first and second damping cylinders 26, 28 furthermore each have circumferentially uniformly distributed compression openings 34 for elastic compression of the two damping cylinders 26, 28 when the damping element 12 is conveyed into its position of use and when it is in its position of use, wherein the compression openings 34 of the first and second damping cylinders 26, 28 are identically designed and arranged on the respective damping cylinder 26, 28, namely in such a manner that the compression openings 34 are each arranged radially with respect to the central retaining opening 14 of the damping element 12.

In the present example, the damping element 12 is designed such that it has essentially identical deformation characteristics in the axial and radial directions. On account of the requirements in the concrete individual case, the damping element 12 is furthermore designed as an elastomer, namely a rubber elastomer. For example, it can be EPDM or NBR here. However, other examples are also possible in which the damping element according to the invention is made from silicone or from a thermoelastomer.

As is further evident from FIGS. 1 and 2, the clamp 22 in the present exemplary example has a retaining projection 36 that corresponds to the connecting cylinder 30 and bears axially against the first and second damping cylinders 26, 28 when the damping element 12 is in the position of use. In contrast thereto, the connecting cylinder 30, in particular because of its dimensioning, does not bear against the retaining projection 36 when the damping element 12 is in the position of use.

The mode of operation of the retaining system according to the invention with the damping element according to the invention in accordance with the first example is explained in detail below on the basis of FIGS. 1 and 2.

Initially, the retaining system 2 is in an uninstalled state depicted in FIG. 1. For the purpose of conveying the retaining system 2 into its installed state, the damping element 12 is conveyed into its position of use, as is apparent from FIGS. 1 and 2 in combination. To this end, the damping element 12 is moved perpendicular to the image plane of FIG. 2 toward the clamp opening 24 of the clamp 22 until the damping element 12 is accommodated in the clamp 22 in the position of use evident from FIG. 2. During this process, the compression openings 34 make it possible for the two damping cylinders 26, 28 to elastically deform sufficiently that the damping element 12 can be conveyed into its position of use through the clamp opening 24 in the manner explained above. In the position of use, the damping element 12 is positioned relative to the clamp 22 in the radial and axial directions, which is to say in horizontal and in vertical terms in the image plane of FIG. 2, by means of the retaining projection 36.

Subsequently, for the purpose of installing the vehicle component 4 on the remainder of the vehicle using the clamp 22 and the damping element 12 positioned in the clamp 22, the component is placed with the central retaining opening 14 on the retaining bolt 16 from top to bottom in the image plane of FIG. 2 so that the second damping cylinder 28 of the damping element 12 rests on the first retaining device 8. In order to make possible a defined force transmission between the vehicle component 4 on the one side and the remainder of the vehicle on the other side by means of the retaining system 2, the first retaining device 8 has a raised support surface 9. Furthermore, a washer 21 is arranged between the attachment nut 20 and the first damping cylinder 26. When the attachment nut 20 is tightened, the damping element 12 is compressed in the axial direction such that the first and second damping cylinders 26, 28 each bear radially and axially against the clamp 22 when the damping element 12 is in its position of use, wherein the connecting cylinder 30 does not bear against the clamp 22, namely against the retaining projection 36. See FIG. 2 in this regard.

If the vehicle component 4 is now moved upward or downward in the image plane of FIG. 2 relative to the remainder of the vehicle, for example on account of inertia, then only the first damping cylinder 26 has a damping action in the case of a relative downward motion of the vehicle component 4, whereas only the second damping cylinder 28 has a damping action in the case of a relative upward motion of the vehicle component 4. This is because the respective damping cylinder 26, 28 is supported in a force-transmitting manner on the retaining projection 36 in the case of axial loading. The flow of force from the vehicle component 4 in this case in FIG. 2 runs in a direct path from the retaining projection 36 to the first retaining device 8 either by means of the first damping cylinder 26 or by means of the second damping cylinder 28. The connecting cylinder 30 makes no contribution thereto.

It is a different matter when the vehicle component 4 in the image plane of FIG. 2 is moved to the left, to the right, into the image plane, or out of the image plane. In these cases, both damping cylinders 26, 28 simultaneously exert damping action counter to this motion. This is because the two damping cylinders 26, 28 are supported radially on the clamp 22 in a force-transmitting manner. The flow of force from the vehicle component 4 in this case in FIG. 2 runs in a direct path from the clamp 22 to the first retaining device 8 both by means of the first damping cylinder 26 and by means of the second damping cylinder 28. The connecting cylinder 30 again makes no contribution thereto.

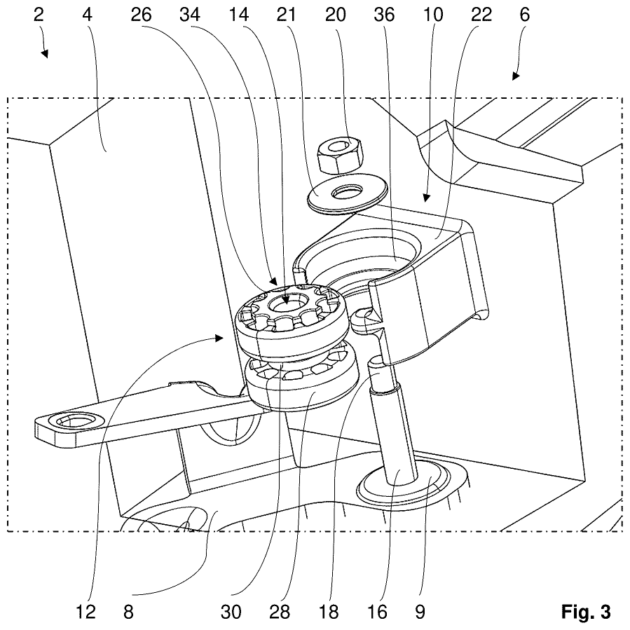

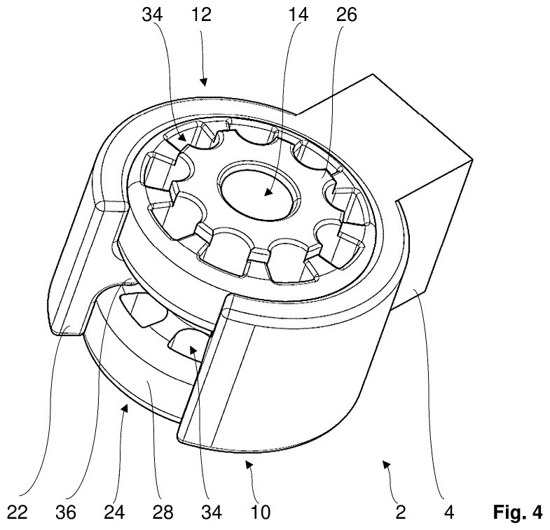

Shown in FIGS. 3 to 5 is a second example of the retaining system according to the invention with the damping element according to the invention. Elements that are identical or have identical functions are labeled with identical reference symbols. Only the differences in the second example as compared to the first example are explained briefly below. In all other respects, the above remarks relating to the first example should be referred to.

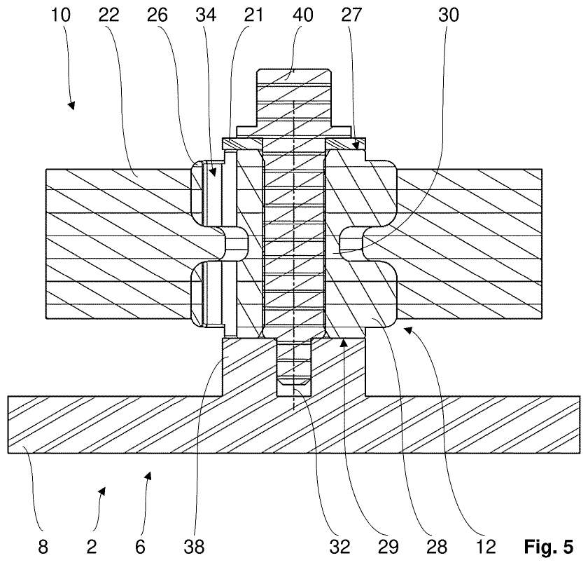

As is clearly evident from FIGS. 3 to 5, the two damping cylinders 26, 28 in the present example have a different basic structure as compared with the first example. On their free end, the first and second damping cylinders 26, 28 in the second example each have a raised mounting surface 27, 29. These mounting surfaces 27, 29 have the advantage that, e.g., the mounting surface 9 as well as the washer 21 according to the first example for the purpose of defined force transmission between the vehicle component 4 and the remainder of the vehicle by means of the damping element 12 can in principle be dispensed with. As is apparent from FIGS. 3 and 5, this not mandatory, however, so that a mounting surface 9 as well as a washer 21 can be used even with the second example, analogously to the first example. Consequently, the first retaining device 8 of the first variant of the retaining system 2 according to the second example shown in FIG. 3 corresponds to the first retaining device 8 of the first example.

In contrast thereto, the first retaining device 8 of the second variant of the retaining system 2 shown in FIG. 5 according to the second example has an attachment section 38, wherein the attachment section 38 has a screw thread corresponding to a separate threaded bolt 40 of the retaining system 2 and is designed as a raised attachment projection. In a variant of the second example similar to the second variant, a sleeve could be arranged between the threaded bolt on the one side and the damping element on the other side, wherein the sleeve has an essentially smooth surface on the side facing the damping element. It is also possible that the aforementioned washer 21 is designed as an integral part of the sleeve in this last-mentioned variant. Of course, the use of an additional sleeve is also applicable to the first variant of the second example as well as to the first example.

In all other respects, the above remarks relating to the first example can be referred to.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A damping element for attachment of a vehicle component to a remainder of a vehicle, the damping element being designed as a one-piece damping element, the damping element comprising:
a first damping cylinder; and
a second damping cylinder, the first and second damping cylinders being connected to one another via a connecting cylinder, the damping element is designed such that, when the damping element is in a position of use, only the first and second damping cylinders bear against the vehicle component and against the remainder of the vehicle in a manner that transmits force in the radial and axial directions.

2. The damping element according to claim 1, wherein the first and second damping cylinders are designed to be identical to one another in their basic structure.

3. The damping element according to claim 1, wherein the first damping cylinder, the second damping cylinder, and the connecting cylinder are each designed to be rotationally symmetric about a common rotational axis in that the damping element has a central retaining opening extending along the common rotational axis or in that the retaining opening is designed as a through hole.

4. The damping element according to claim 1, wherein the first and second damping cylinders each have circumferentially uniformly distributed compression openings for elastic compression of the two damping cylinders when the damping element is conveyed into its position of use, wherein the compression openings of the first and second damping cylinders are designed and arranged on the respective damping cylinder in an identical manner or the compression openings are each arranged radially with respect to a central retaining opening of the damping element.

5. The damping element according to claim 1, wherein the first and second damping cylinders each have, on their free front end, a raised mounting surface for attachment to the remainder of the vehicle, wherein the mounting surface is designed as a mounting surface and arranged circumferentially around a central retaining opening of the damping element or the mounting surface is designed as a mounting surface arranged essentially between the central retaining opening and the compression openings of the damping element.

6. The damping element according to claim 1, wherein the damping element is designed such that it has essentially identical deformation characteristics in the axial and radial directions.

7. The damping element according to claim 1, wherein the damping element is designed as a silicone or an elastomer, wherein the damping element is designed as a rubber elastomer, or wherein the damping element is made from EPDM or NBR.

8. A retaining system for a vehicle for attachment of a vehicle component to a remainder of the vehicle, the retaining system comprising:
at least one retaining device group with, in each case, a first retaining device arranged in a force-transmitting manner on the remainder of the vehicle, a second retaining device corresponding to the first retaining device and arranged in a force-transmitting manner on the vehicle component; and
the damping element according to claim 1 being arranged between the first and second retaining devices.

9. The retaining system according to claim 8, wherein the retaining system has a multiplicity of retaining device groups, wherein three retaining device groups and the retaining device groups are designed and arranged such that the vehicle component has, via the damping elements, essentially the same damping in the axial and radial directions relative to each of the damping elements.

10. The retaining system according to claim 8, wherein the first retaining device of at least one retaining device group has a retaining bolt corresponding to a central retaining opening of the damping element, and wherein the retaining bolt is designed as an attachment bolt, and wherein the attachment bolt has, at its free front end, a screw thread.

11. The retaining system according to claim 8, wherein the first retaining device of at least one retaining device group has an attachment section, wherein the attachment section has a screw thread corresponding to a separate threaded bolt of the retaining system, and wherein the attachment section is designed as a raised attachment projection.

12. The retaining system according to claim 8, wherein the second retaining device of at least one retaining device group is designed as a clamp that only partially encompasses the damping element when it is in its position of use and that has a clamp opening on its circumference, wherein the clamp and the damping element are matched to one another in design such that the damping element is conveyed into its position of use through the clamp opening, and wherein the clamp has a retaining projection that corresponds to the connecting cylinder and bears axially against only the first and second damping cylinders.
